(19) United States
(12) Patent Application Publication
(10) Pub. No.: US 2013/0084033 A1
(43) Pub. Date: Apr. 4, 2013

(54) ELECTRICALLY INSULATING BEARING RING, IN PARTICULAR FOR A ROLLER BEARING

(71) Applicants: Gudrun Martin, Euerbach (DE); Xiao Nie, Herzogenaurach (DE)

(72) Inventors: Gudrun Martin, Euerbach (DE); Xiao Nie, Herzogenaurach (DE)

(73) Assignee: SCHAEFFLER TECHNOLOGIES AG & CO. KG, Herzogenaurach (DE)

(21) Appl. No.: 13/641,527

(22) PCT Filed: Apr. 12, 2011
(86) PCT No.: PCT/EP2011/055683

§ 371 Date: Dec. 12, 2012

(30) Foreign Application Priority Data
Apr. 16, 2010 (DE) 10 2010 015 155.6

(51) Int. Cl. F16C 33/58

(52) U.S. Cl. CPC F16C 33/58
USPC 384/445

(57) ABSTRACT

An electrically insulating bearing ring, in particular of a roller bearing, including a base body (2) and an electrically insulating layer (3) which is secured to the base body (2). The problem of providing an electrically insulating bearing ring, in particular of a roller bearing, with only a small layer thickness of the electrically insulating layer, is achieved according to the invention in that the electrically insulating layer (3) includes a polyamide, that the electrically insulating layer (3) has a thickness of approximately 20 microns to approximately 200 microns and that the electrically insulating layer (3) is securely arranged on the base body (2) by an intermediate layer (9).

### FIELD OF THE INVENTION

The invention relates to an electrically insulating bearing ring, in particular for a rolling bearing, and to a bearing, in particular a rolling bearing.

It is known from practice that electrical current passing through a bearing can lead to the bearing being damaged. There is therefore a need for electrically insulating bearings, in particular electrically insulating bearing rings.

### BACKGROUND

The prior art discloses ceramic layers that are secured as electrically insulating layers on a metallic, that is to say electrically conducting, base body of the bearing ring. Such ceramic layers are sensitive to impact and can easily peel off. Furthermore, ceramic layers are not suitable when there is a thin-walled base body or on sharp-edged portions of the base body.

The prior art also discloses coverings, in particular injection-molded parts, for example consisting of a plastic, which, produced independently of the base body, are clipped or pressed onto the base body. In order to ensure a secure hold on the base body, the injection-molded parts have ribs which engage in assigned grooves on the surface of the base body, so that the injection-molded parts have a layer thickness of about several millimeters. These coverings have a disadvantageous effect on the removal of heat from the base body, and consequently the bearing as a whole. Furthermore, dirt or moisture can get into the gap between the covering and the base body. It is also unfavorable that the layer thickness must be taken into consideration in the structural design of the bearing ring.

JP 2003 120688 AA (Abstract) describes a covering formed of a resin.

DE 690 16 321 T2 describes a bearing ring comprising a base body and an electrical insulating layer formed of a polyurethane (PUR), which is secured on the base body and has a layer thickness of about 0.5 of a millimeter, the electrical insulating layer being covered over by a metal plate, which mechanically protects and stabilizes the electrical insulating layer.

U.S. Pat. No. 6,513,986 B2 describes a bearing ring with a base body on which an electrically insulating layer is provided, the electrically insulating layer is formed of a resin based on polyphenylene sulfide and polyamide-imide as well as inorganic additives. The electrically insulating layer is secured like a covering over a projecting rib to an assigned groove on the base body, so that the electrically insulating layer must have a layer thickness in the range of about 1 millimeter or more.

U.S. Pat. No. 5,975,764 A describes an electrically insulating covering formed of a synthetic rubber or a synthetic resin. The covering has a projecting rib which engages in an assigned groove on the base body of the bearing ring, so that the covering has a layer thickness of about 1 millimeter or more.

U.S. Pat. No. 5,375,933 A describes an electrically insulating covering of a polyphenylene sulfide resin that comprises glass fibers as reinforcement. This covering too must have a thickness of 1 millimeter or more.

JP 2007 315585 AA (Abstract) describes a bearing ring on the base body of which a strip of a polyamide 9T resin is disposed in each of two peripheral grooves in order to form a means of mechanically prestressing the bearing ring in relation to a bearing receptacle. The strips, which are spatially separate from each other, do not bring about any electrical insulation of the bearing ring.

JP 11030239 AA (Abstract) describes a bearing ring with an electrically insulating covering which is formed in one part with a seal, the electrically insulating covering being produced from a synthetic resin, a thermoplastic elastomer or a synthetic rubber.

JP 10184699 AA (Abstract) describes a bearing ring on the base body of which there lies an electrically insulating covering, which is formed from a thermoplastic elastomer. This covering too has a great layer thickness.

JP 10306828 AA (Abstract) describes a bearing ring on the base body of which an electrically insulating covering of a polyamide resin with fiber additives has been sprayed. This layer too has a great layer thickness of the electrically insulating layer.

JP 2002 168253 AA (Abstract) describes an electrically insulating bearing ring on the base body of which a covering consisting of a resin, in particular of a polyphenylene sulfide resin with a polyamide-imide resin and admixed inorganic insulating materials, is provided.

### SUMMARY

It is the object of the invention to provide an electrically insulating bearing ring, in particular for a rolling bearing, with an only small layer thickness of the electrically insulating layer.

This object is achieved according to the invention by the electrically insulating layer comprising a polyamide as the plastic component, in particular a polyamide as the only plastic component, by the electrically insulating layer having a thickness of about 20 microns to about 200 microns, and by the electrically insulating layer being securely arranged on the base body by means of an intermediate layer.

It has proven to be the case that, in spite of the small layer thickness of only about 20 microns to about 200 microns, a high electrical resistance that is stable over time of about 50 megaohms can be achieved under dry conditions. The intermediate layer, which is arranged between the insulating layer consisting of the polyamide, in particular the polyamide as the only plastic component of the insulating layer, and the base body and imparts adhesion to both sides, ensures the durable bonding of the electrically insulating layer to the base body.

The base body provided with the electrically insulating layer corresponds in its dimensions to a standard bearing if the base body is supplied in a form in which it has somewhat smaller dimensions and only a slight undersize that corresponds to the layer thickness of about 20 microns to about 200 microns.

The relative change in thickness of the electrically insulating layer when an increase in temperature to about 120° C. is carried out under mechanical compressive loading in a fatigue test is more than about 2%, which however is acceptable due to the small layer thickness of less than about 200 microns.

In particular, electrically insulating bearing rings with diameters of about 30 to about 500 mm can be provided with the electrically insulating layer.

It is preferably provided that the electrically insulating layer consists exclusively of the polyamide or a mixture of polyamides. The plastic component of the electrically insulating layer may consist exclusively of the polyamide, for example polyamide-11 or polyamide-12. As an alternative to this, the plastic component of the electrically insulating layer may consist of a mixture (blend) of different polyamides, for example a mixture of polyamide-11 with polyamide-12. The electrically insulating layer may comprise polyamide, either in pure form or as a mixture with inorganic additives that are not plastic, which may make up less than 50 percent by weight of the electrically insulating layer.

It is preferably provided that the polyamide is a polyamide-11 or a polyamide-12. Polyamide-11 or polyamide-12 or mixtures of polyamide-11 with polyamide-12 have a much lower capability for absorbing moisture than other polyamides such as polyamide-6, polyamide-66 or polyamide-46, so that the electrical insulating properties improve. The data on the specific polyamides correspond here to the ISO standard ISO 1043.

It is preferably provided that the thickness of the electrically insulating layer is about 100 mirometers. At a much greater thickness, mechanical stresses occur within the electrically insulating layer, in particular at edges of the base body. At a much smaller thickness, a complete and durable electrical insulation that extends along the entire outer circumferential surface and the end faces is complex to produce.

It is preferably provided that the intermediate layer is formed by a roughened surface of the base body, the polyamide filling the interfacial cracks that are caused by the roughness. The roughened surface of the base body may, for example, be produced by means of a mechanical blasting method, so that interfacial cracks occur, such as unevennesses and grooves, into which the polyamide applied to the roughened surface of the base body penetrates in order to form an interlocking mechanical structure between the electrically insulating layer and the base body. The mechanical blasting method may be, for example, sand blasting, an average roughness R_{A} of about 3 microns being sufficient for a secure bonding of the electrically insulating layer to the base body, for example of a rolling bearing steel.

As an alternative or in addition to the intermediate layer formed by a roughened surface of the base body, it is preferably provided that the intermediate layer is formed by a layer of an inorganic material, in particular by a zinc phosphate layer. The zinc phosphate layer has in this case a layer thickness of about 3 microns and can be easily produced, for example by a wet-chemical process.

It is preferably provided that the electrically insulating layer is formed as a spray coating that is cured by heat treatment and subsequently re-worked by a grinding process. The electrically insulating bearing ring can then be easily produced, by providing the base body, applying the intermediate layer to the base body, either by applying the layer of an inorganic material or by roughening the surface of the base body in the region of the outer circumferential surface or the two end faces, applying a spray emulsion of the polyamide, in particular of polyamide-11, polyamide-12 or a mixture of polyamide-11 with polyamide-12, and subsequently performing heat treatment at temperatures of up to about 200° C., after which the spray coating cured by the heat treatment is finally reduced to size by grinding or machining.

It is preferably provided that, in addition to the polyamide, the electrically insulating layer contains glass fibers, the glass fibers mechanically stabilizing the electrically insulating layer and contributing to the electrical insulation.

Further advantages and features of the invention emerge from the dependent claims and from the description of an exemplary embodiment.

### BRIEF DESCRIPTION OF THE DRAWINGS

The invention is described in more detail and explained below with reference to the appended drawings.

FIG. 1 shows a partially sectioned perspective view of a first exemplary embodiment of a bearing ring according to the invention,

FIG. 2 shows a sectioned schematic view of an enlarged detail of the first exemplary embodiment of the bearing ring according to the invention, and

FIG. 3 shows a sectioned schematic view of an enlarged detail of a second exemplary embodiment of a bearing ring according to the invention.

### DETAILED DESCRIPTION OF THE PREFERRED EMBODIMENTS

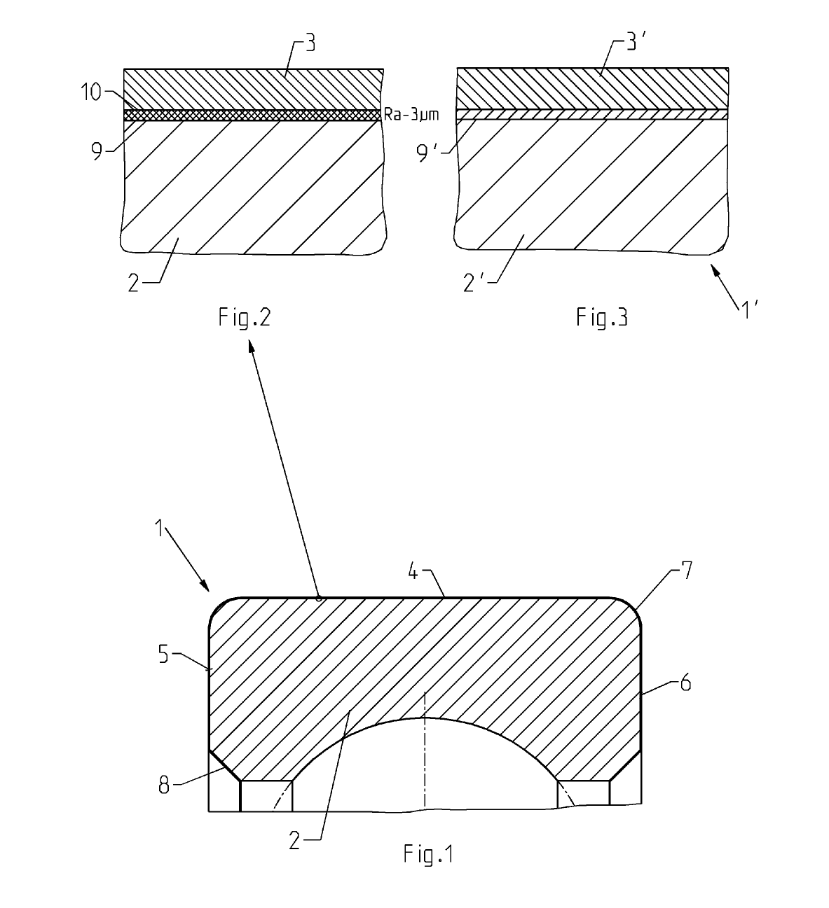

FIG. 1 shows a bearing ring 1 of a bearing, to be specific a rolling bearing, especially a ball bearing, the body of the bearing ring 1 comprising a base body 2 of an electrically conducting material, to be specific a rolling bearing steel, and an electrically insulating layer 3 securely arranged on the base body 2. The electrically insulating layer 3 has a layer thickness of about 100 microns, and is consequently much thinner than the wall thickness of the base body 2 of the bearing ring 1. In the representation of FIG. 1, the electrically insulating layer 3 is depicted as a thickening of the outline of the sectioned base body 2 and is shown exaggerated in its layer thickness.

The electrically insulating layer 3 extends as a continuous coating with an approximately constant layer thickness along the outer circumferential surface 4 and the two end faces 5, 6 of the bearing ring 1. The electrical insulating layer 3 likewise covers with substantially the same layer thickness of about 100 microns over the edges 7 between the outer circumferential surface 4 and the end faces 5, 6 as well as bevels 8 of the end faces 5, 6.

The electrically insulating layer 3 was applied as a spray coating of a polyamide, to be specific of polyamide-11, then cured by a heat treatment and subsequently re-worked by a grinding process, in particular reduced to size. Before applying the electrically insulating layer 3, the edges 7 had been rounded. The electrically insulating layer 3 consequently consists completely of the cured polyamide-11.

FIG. 2 shows a detail of the interface of the base body 2 and the electrically insulating layer 3 from the exemplary embodiment represented in FIG. 1. It can be seen that the electrically insulating layer 3 is secured on the base body 2 by means of an intermediate layer 9, the intermediate layer 9 being formed by a roughening of the surface of the base body 2 with an average roughness R_{A} of about 3 microns, interfacial cracks 10, such as grooves and unevennesses, being obtained on the previously smooth surface of the base body 2, and the polyamide of the electrically insulating layer 3 penetrating into the interfacial cracks 10 that are caused by the roughness.

Not depicted are glass fibers, as a further constituent of the material of the electrically insulating layer 3.

FIG. 3 shows a representation analogous to that from FIG. 2 of a further electrically insulating bearing ring 1′, an intermediate layer 9′ being provided between a base body 2′ and an electrically insulating layer 3′ of a mixture of polyamide, to be specific a mixture of polyamide-11 with polyamide-12. The intermediate layer 9′ is formed by a layer 11 of an inorganic material, to be specific by a zinc phosphate layer of about 3 microns in layer thickness, the zinc phosphate layer having been deposited on the substantially smooth surface of the base body 2′ by a wet-chemical process.

In the case of the exemplary embodiments described above, the electrically insulating layer 3, 3′ comprises the polyamide in the sense that the electrically insulating layer 3 consists completely of polyamide-11 or the electrically insulating layer 3′ consists completely of the mixture of polyamide-11 and polyamide-12. It goes without saying that the electrically insulating layer may also comprise polyamide in the sense that the polyamide mixed with some other plastic, for example PEEK or PPS, may form the electrically insulating layer. It also goes without saying that, in addition to the polyamide or the mixture of the one polyamide with the other polyamide or the mixture of the polyamide with some other plastic, the electrically insulating layer may also have additives, such as for example ceramic additives or glass fibers.

### List of Reference Numbers

1 bearing ring
2, 2′ base body
3, 3′ electrically insulating layer
4 outer circumferential surface
5, 6 end face
7 edge
8 bevel
9, 9′ intermediate layer
10 interfacial crack
11 layer

1. An electrically insulating bearing ring, comprising
a base body, and
an electrically insulating layer secured on the base body,
the electrically insulating layer comprises a polyamide,
the electrically insulating layer has a thickness of about 20 microns to about 200 microns, and
the electrically insulating layer is securely arranged on the base body by an intermediate layer.

2. The electrically insulating bearing ring as claimed in claim 1, wherein the thickness of the electrically insulating layer is about 100 microns.

3. The electrically insulating bearing ring as claimed in claim 1, wherein the intermediate layer is formed by a roughened surface of the base body, the polyamide fills interfacial cracks that are caused by the roughened surface.

4. The electrically insulating bearing ring as claimed in claim 1, wherein the intermediate layer is formed by a layer of an inorganic material.

5. The electrically insulating bearing ring as claimed in claim 1, wherein the electrically insulating layer is formed as a spray coating that is cured by heat treatment and subsequently re-worked by a grinding process.

6. The electrically insulating bearing ring as claimed in claim 1, wherein the electrically insulating layer consists exclusively of the polyamide.

7. The electrically insulating bearing ring as claimed in claim 1, wherein the polyamide is a polyamide-11 or a polyamide-12.

8. The electrically insulating bearing ring as claimed in claim 1, wherein in addition to the polyamide, the electrically insulating layer contains glass fibers.

9. A rolling bearing, comprising an electrically insulating bearing ring as claimed in claim 1.

10. The electrically insulating bearing ring as claimed in claim 4, wherein the inorganic material is a zinc phosphate layer.

11. The electrically insulating bearing ring as claimed in claim 1, wherein the electrically insulating layer consists of a mixture of polyamides.
